(19) United States
(12) Patent Application Publication
(10) Pub. No.: US 2008/0066846 A1
(43) Pub. Date: Mar. 20, 2008

(54) Motor Vehicle Pneumatic Tire

(75) Inventor: Markus Metz, Neustadt (DE)

Correspondence Address: GREENBLUM & BERNSTEIN, P.L.C., 1950 ROLAND CLARKE PLACE, RESTON, VA, 20191, US

(73) Assignee: CONTINENTAL AKTIENGESELLSCHAFT, Hannover (DE)

(21) Appl. No.: 11/573,247

(22) PCT Filed: Jul. 5, 2005
(86) PCT No.: PCT/EP05/07204

§ 371 Date: Jun. 28, 2007

(30) Foreign Application Priority Data
Aug. 6, 2004 (DE) 10 2004 038 142.9

(51) Int. Cl. B60C 13/02

(52) U.S. Cl. 152/523

(57) ABSTRACT

Vehicle pneumatic tire with a carcass, in particular of radial construction, with sidewalls and with a tread rubber (1), whereby a moiré-free pattern is arranged in a first surface area of a sidewall rubber strip (7), which pattern is formed by one or more linear families of curves, and a moiré pattern is arranged in a second surface area connecting to the first surface area in the circumferential direction of the vehicle pneumatic tire, which pattern is formed embodied from the superimposition of at least two linear non-identical families of curves. Sidewall rubber strip (7) is embodied free from markings to provide information, whereby a moiré pattern is arranged on the surface of the sidewall rubber strip (7), which pattern is formed embodied from the superimposition of at least two linear non-identical families of curves, characterized in that in the second surface area on the sidewall rubber strip (7).

The invention relates to a vehicle pneumatic tire with a carcass, in particular of radial construction, with sidewalls and with a tread rubber, whereby the carcass in the sidewall area is covered on the outside by a sidewall rubber strip, whereby in at least one first surface area of the sidewall rubber strip markings for providing information are embodied, whereby at least in a second surface area of the sidewall rubber strip joining the first surface area in the circumferential direction of the vehicle pneumatic tire is embodied free from markings for providing information, whereby a moiré pattern is arranged on the surface of the sidewall rubber strip, which pattern results formed by the superimposition of at least two linear non-identical families of curves.

It is known to build vehicle pneumatic tires from several different layers, e.g., with tires of radial construction, from inner liner, carcass, belt and tread and in the side region from inner liner, carcass and side part from the radial inside to the radial outside. Carcasses of vehicle pneumatic tires are usually built from one or more plies of strength supports embedded in rubber respectively parallel to one another. The individual carcass plies are thereby produced from continuous rubber bands with strength supports arranged parallel in the rubber band direction. Depending on the desired bias position of the strength supports to the tire equator plane, the rubber bands provided with embedded strength supports are usually cut into individual pieces on the bias in the subsequent tire construction or transversely for radial carcass construction. The uncut sides of the pieces thus obtained, which previously already represented the sides of the rubber band, are then usually connected to one another to form a continuous carcass ply. As soon as the carcass length desired for the circumference of the tire has been reached, the carcass ply formed from the individual carcass pieces cut on the bias or transversely is placed on the building drum on the already prepared inner layer, on a carcass layer already placed there or, if necessary, on additional intermediate layers. The carcass ply is thereby laid around the entire circumference and usually with its end areas connected to one another with individual strength supports being overlapped. Subsequently, depending on the desired design, additional carcass layers, intermediate layers, belt plies and tread are applied. During the production process it is customary to produce the desired green tire form by expanding the building drum provided with the carcass plies in the radial direction during shaping.

After the vulcanization and finishing of the tire, as soon as it has been inflated to its operating state, thickened areas, which have been produced by the overlapping of several strength supports in the carcass structure, become noticeable in a negative way in particular in the outer carcass ply. The strength supports are namely greatly stretched by the shaping and are shrunk during the subsequent vulcanization, so that particularly solid carcass regions result here. As soon as the tire in its fitted state is loaded with internal pressure, this solidified area in particular exhibits a substantially weaker expansion behavior than the surrounding carcass regions. The differing strength and elasticity behavior of the carcass in these regions leads to visibly detectable constrictions. This is particularly noticeable when polyester is used for the carcass strength supports.

Several suggestions have been made for reducing or optically masking the constrictions arising from the overlapping.

For example, EP 0 239 160 B1 proposes providing additional splicing strips in the overlapping region. EP 0 407 134 B1 proposes applying additional rubber strips in the overlapping region at least in the region of the bead core, which strips are to serve as elastic cushions in the core region so that where there is excess internal pressure, the strength supports in the overlapping region migrate radially outwards from the core under elastic compression of the cushion, and the constriction ought thus to be largely masked. The quality of the masking of the constriction behavior thereby depends on the thickness of the rubber strip used. The additional strip leads to the development of additional uniformity problems as compared to conventional tires depending on the thickness of the strip. Depending on the thickness of the rubber strip, additional air inclusions can form on both sides of the strip between the layer covering the rubber strip and the carcass layer. At great expense, for example by additional rolling of the layer covering the rubber strip, a distribution of the air inclusions is conceivable, at least when the rubber strips between the covering layer and the carcass are thin, but the elongated covering of the carcass ply by the covering layer prevents the removal of the air inclusions. Insofar as they have been distributed from the direct region of the rubber strip, they are nevertheless essentially retained as air inclusions between the carcass and the covering layer and lead to additional problems regarding the durability of the tire. Due to the problems arising from this, satisfactory masking of the constrictions with the aid of an additional rubber strip of this type can be realized, if at all, only with considerable additional expense for the removal of the air inclusions and for the elimination of the additional uniformity problems.

It is known from DE 199 06 658 C2 to arrange a moiré pattern on the sidewall rubber strip, which pattern is formed from the superimposition of at least two linear families of curves. Through the distribution of the intensity of the reflected light as a result of the interferences of the line patterns, the formation of a moiré pattern from linear elevations causes a superimposition on the tire sidewall such that these comparatively slight changes in reflection caused by possible constriction effects are hardly perceptible by the naked eye. This can be implemented within the scope of tire sidewall decorative design without the laborious measures known from EP 0407134B1.

In the area of the tire sidewall important information on the vehicle pneumatic tire is embodied as characters or images on the sidewall rubber strips usually in individual circumferential sections. The desired effects of the moiré pattern to mask constriction effects can impair the visibility of the characters or images.

The object of the invention is therefore to make it possible for informational markings applied to the surface of a tire sidewall to be more easily visible to the naked eye while retaining a simple masking of undesired irregularities in the tire sidewall using the advantageous effect of the moiré effect.

The object is attained according to the invention by the embodiment of a vehicle pneumatic tire with a carcass, in particular of radial construction, with sidewalls and with a tread rubber, whereby the carcass in the sidewall area is covered on the outside by a sidewall rubber strip, whereby markings for providing information are embodied in at least one first surface area of the sidewall rubber strip, whereby at least in a second surface area of the sidewall rubber strip joining the first surface area in the circumferential direction of the vehicle pneumatic tire is embodied free from markings for providing information, whereby a moiré pattern is arranged on the surface of the sidewall rubber strip, which pattern is produced by the superimposition of at least two linear non-identical families of curves, according to the features of claim 1, in which a moiré pattern is arranged in the second surface area on the sidewall rubber strip, which pattern is produced embodied by the superimposition of at least two linear non-identical families of curves and in which a moiré-free pattern is arranged in the first surface area on the sidewall rubber strip, which pattern is embodied from one or more linear families of curves.

The moiré-free pattern surrounding the informative markings intensifies the light reflexes from the irregularities of the informative markings forming the tire sidewall and particularly emphasized by this pattern, so that they can be seen particularly well by the naked eye in this first surface area in which the essential irregularities are the informational markings intended to be seen. In this surface area these targeted and relatively marked irregularities caused by the informative markings themselves mask other irregularities of the tire sidewall caused, e.g., by constriction effects so much that they are hardly perceptible to the human eye in this surface area. In the adjacent second surface area in the circumferential direction of the vehicle pneumatic tire, the unintentional irregularities essential in this area and not desired to be seen through the moiré pattern are reliably masked by the use of the moiré effect. In this manner it can be rendered possible using simple means that intentional irregularities in the form of informational markings are easily seen by the human eye and irregularities not intended to be seen are masked such that they are hard to see with the naked eye.

Particularly advantageous is the embodiment of a vehicle pneumatic tire according to the features of claim 2, in which in the transition of the two surface areas adjacent in the circumferential direction of the vehicle pneumatic tire curves of a first family of curves of the first circumferential section merge smoothly into respectively one curve of a first family of curves of the second circumferential section. Through this the entire surface formed from the two surface areas appears to be a smooth transitionless surface, so that due to the different effects of the two surface embodiments the human eye does not notice those irregularities of the tire sidewall surface that it is not intended to notice and notices particularly well those irregularities that it is intended to notice for informative purposes, whereby the different embodiment of the surfaces is hard to distinguish.

Claims 3 through 15 contain preferred embodiments of the invention.

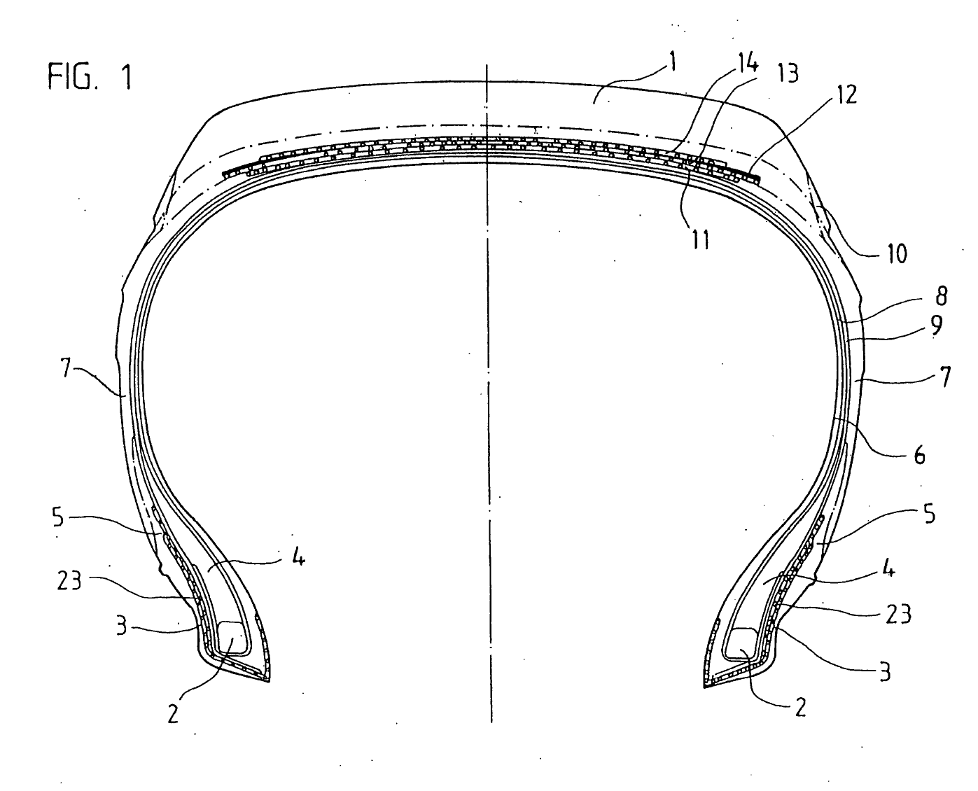

The invention is described below based on the exemplary embodiments shown in more detail in FIGS. 1 through 8.

They show:

FIG. 1 The diagrammatic structure of a tire in cross-sectional view,

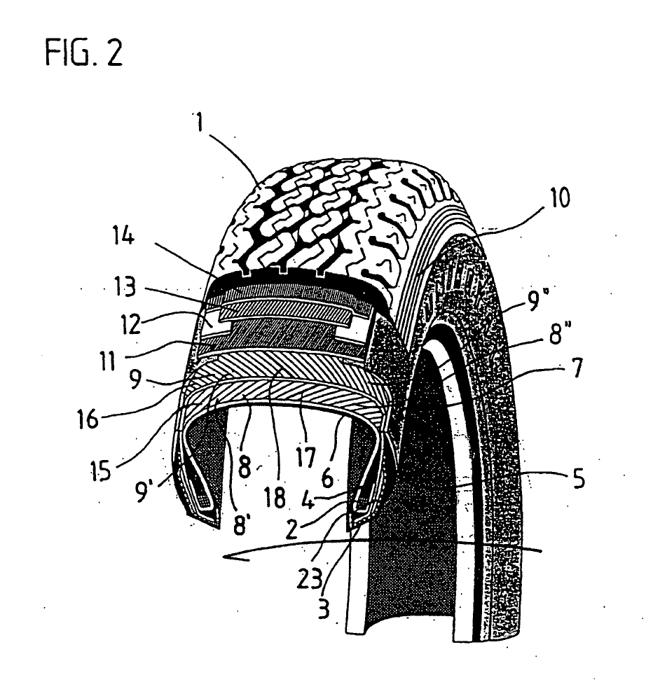

FIG. 2 The diagrammatic tire structure in perspective view,

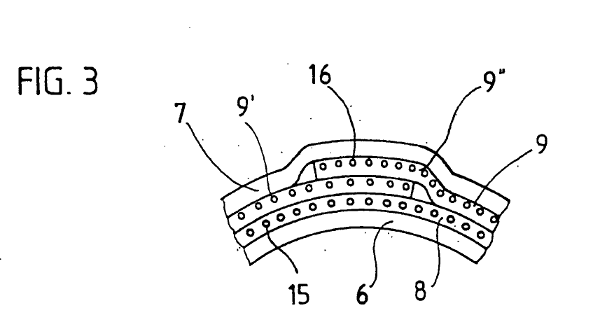

FIG. 3 Diagrammatic representation of the ply cover in the building process,

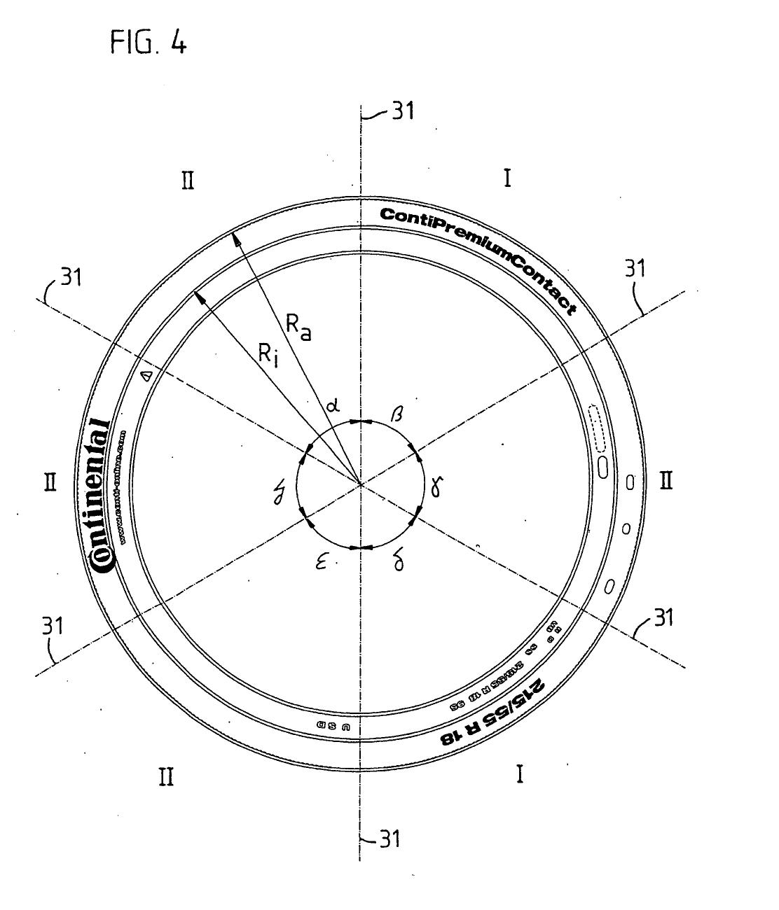

FIG. 4 Diagrammatic representation of a sidewall with different circumferential sections,

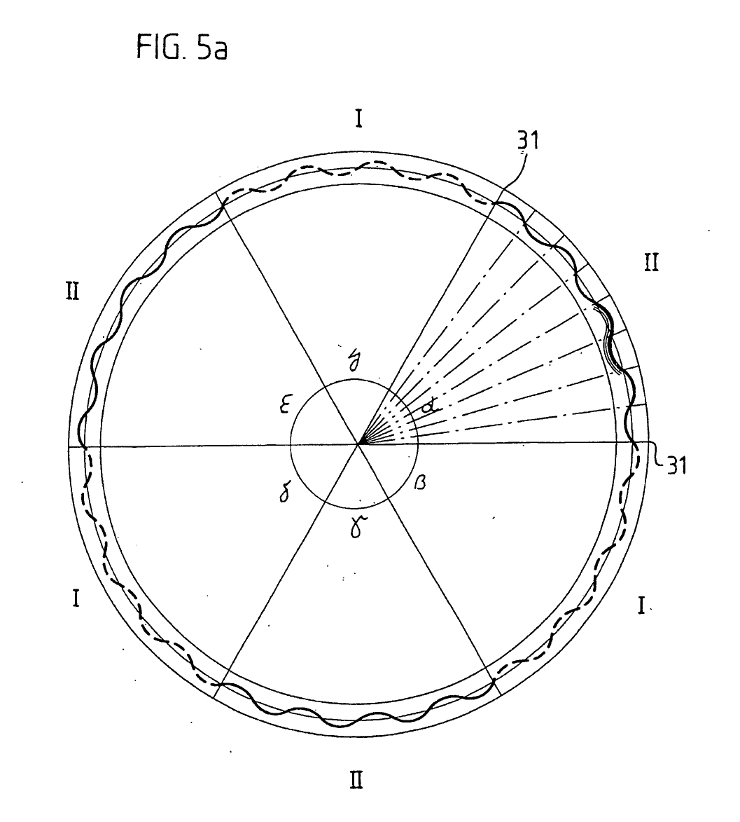

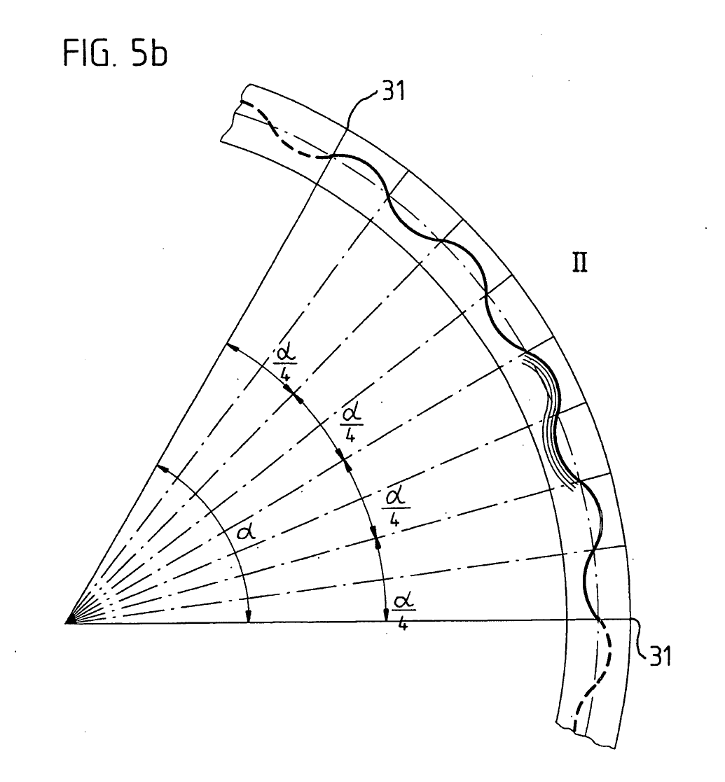

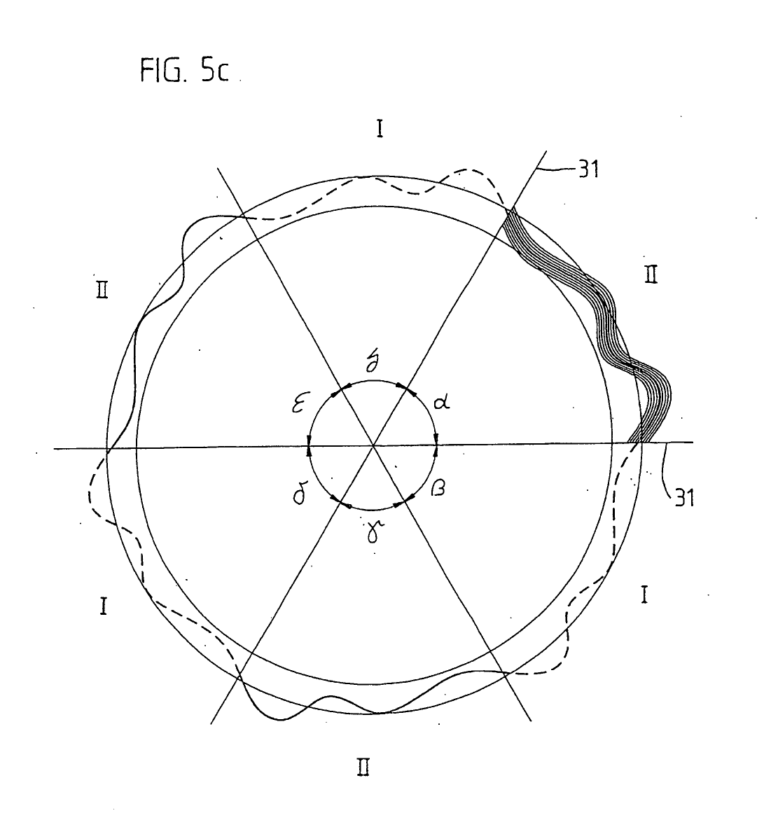

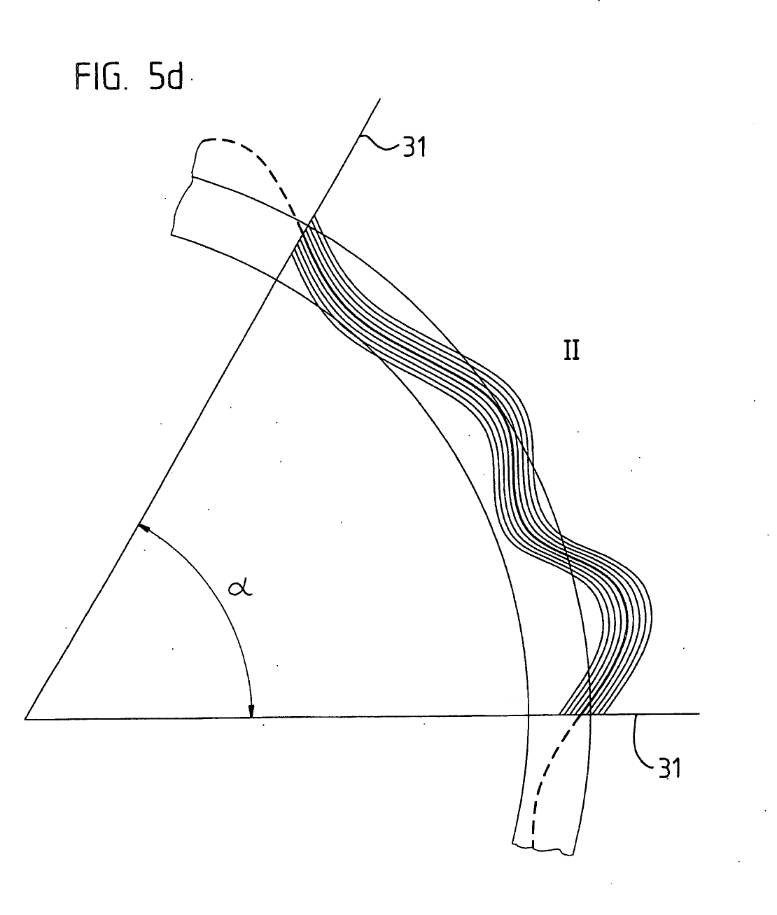

FIG. 5 Diagrammatic representation of a sidewall to explain the moiré pattern,

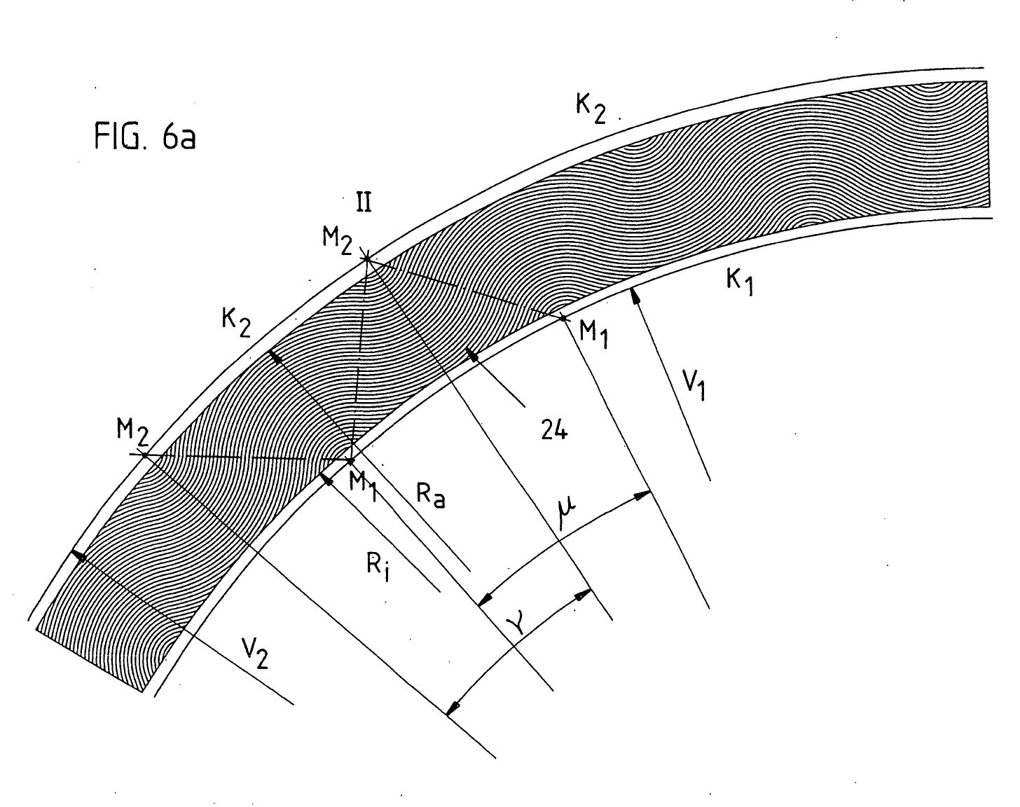

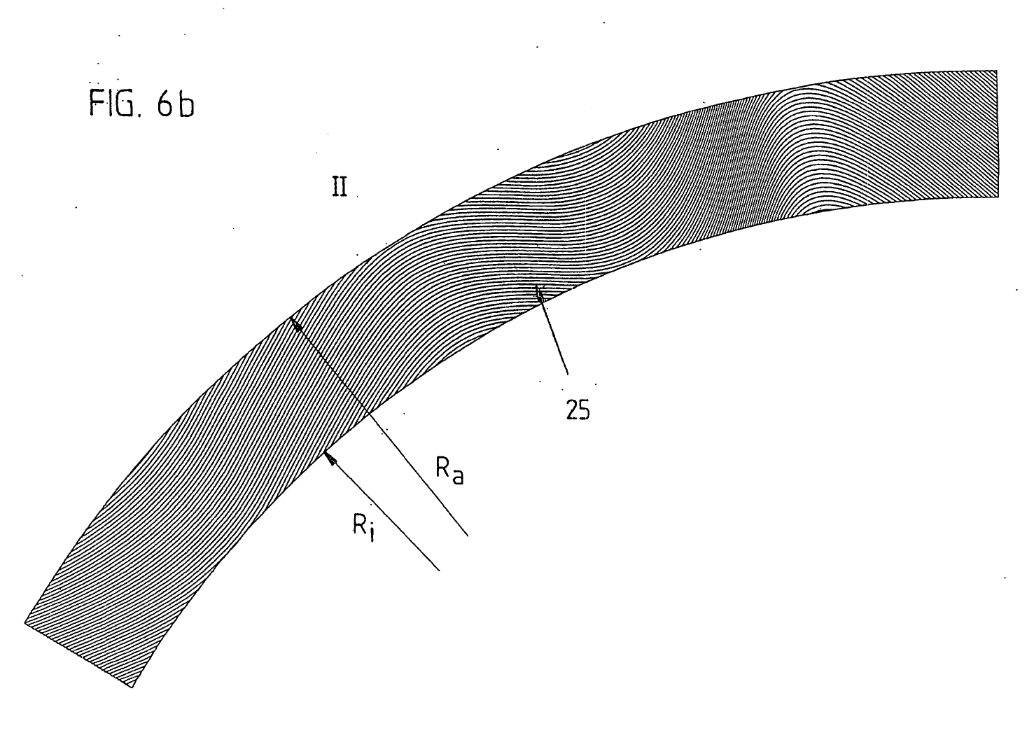

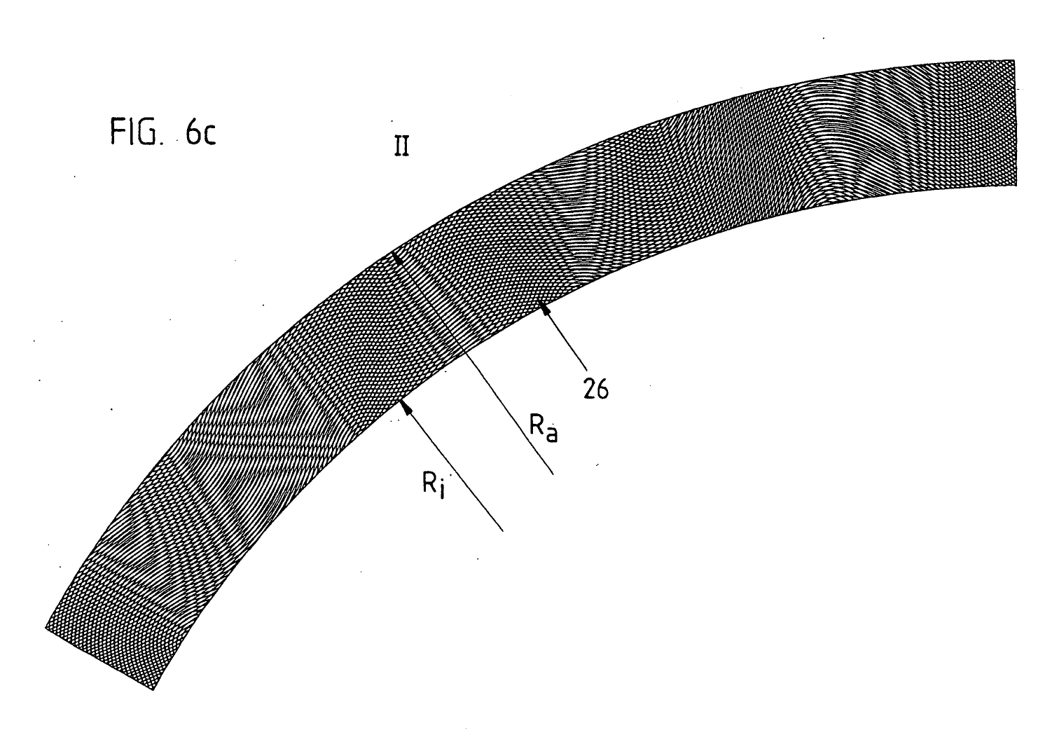

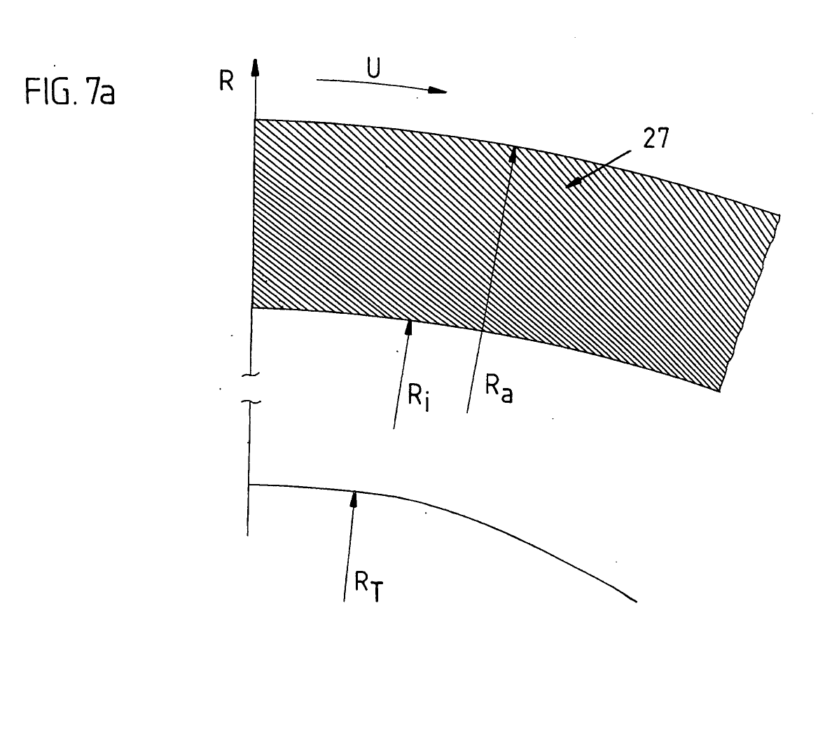

FIG. 6 Diagrammatic representation of a second surface region of a sidewall without informational markings but with a moiré pattern,

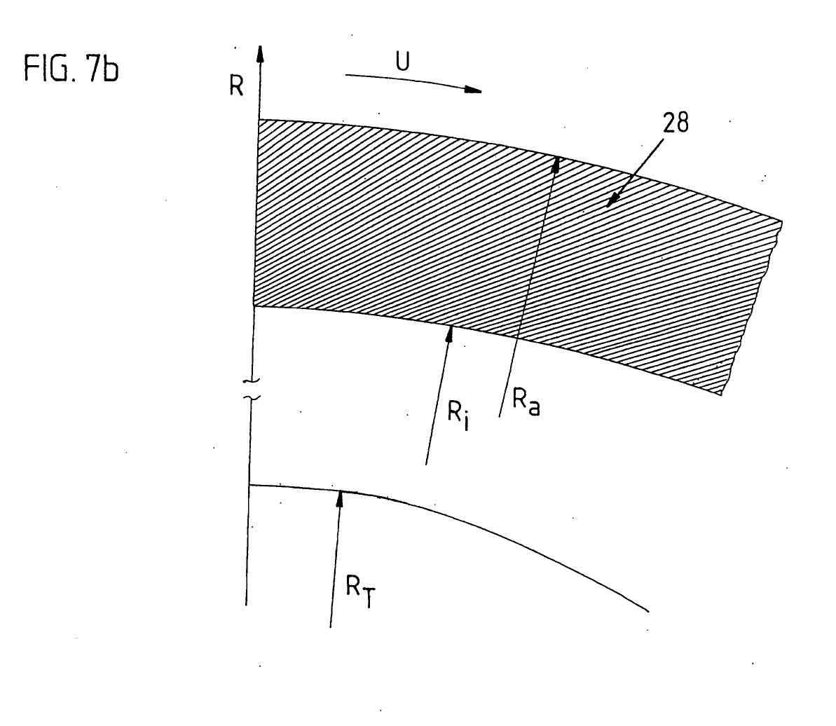

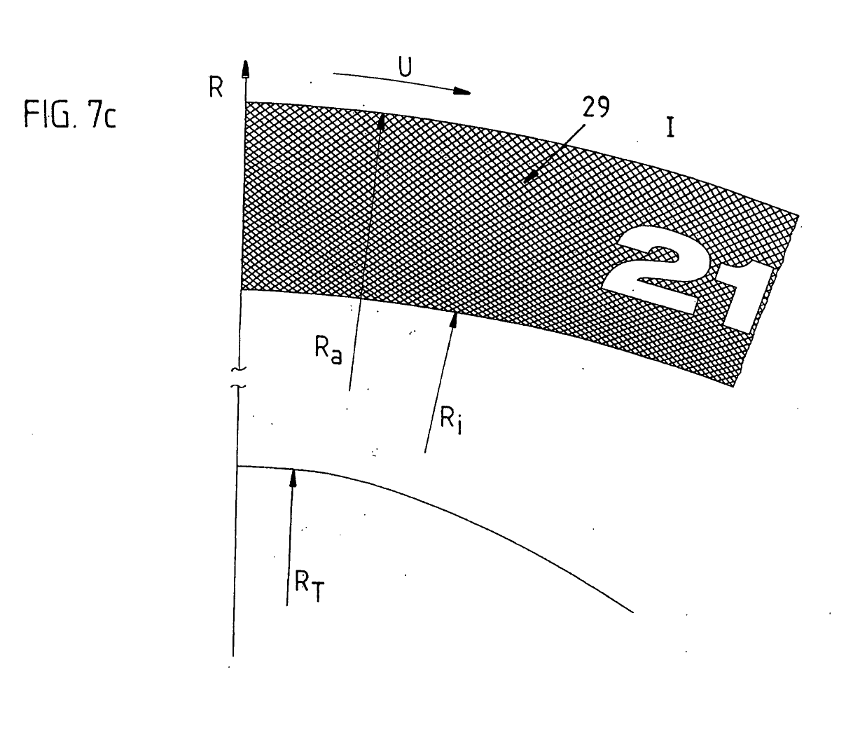

FIG. 7 Diagrammatic representation of a first surface region of a sidewall with informational markings but with a moiré-free pattern,

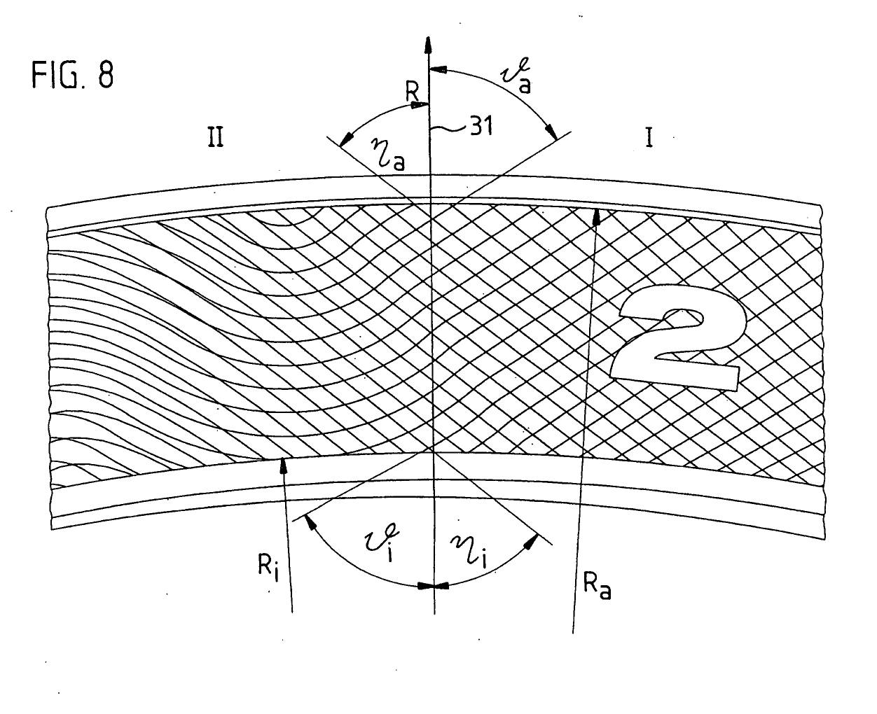

FIG. 8 Diagrammatic representation of the transition between first and second surface area.

FIGS. 1 and 2 show the structure of a vehicle pneumatic tire by way of example, in which a first carcass ply 8 around a core 2 with core profile 4 extends beyond an impermeable inner layer 6 over the right shoulder region and the zenith plane to the left shoulder region and the left core 2 with core profile 4, around which it is laid in the conventional manner. A second carcass ply 9, which likewise extends from the side of the tire shown on the right in FIG. 1 to the side shown on the left, is laid in a conventional manner over the first carcass ply 8. Both carcass plies are manufactured in a conventional manner from a carcass ply/rubber mixture of known type and with rubber bands built up with textile yarns 8 or 9 of known construction embedded therein and lying respectively parallel to one another.

These rubber bands are cut on the bias on a cutting table in a known manner and are then joined to one another at their parallel uncut sides.

For each carcass ply, two carcass pieces 8′, 8″ or 9′, 9″ of this type respectively are shown in FIG. 2. The carcass ply piece 8′ is laid on the carcass ply piece 8″ at the joint 17 such that individual yarns overlap each other. The carcass ply piece 9′ is likewise laid on the carcass piece 9″ at the joint 18 with overlapping.

In the exemplary embodiment of FIG. 2, a flange profile 5 is laid in the core region over a bead strip 23 and the bead reinforcement 3 in a conventional manner, and starting from this flange profile a side strip 7 is laid extending into the shoulder region. Several steel belt plies 11, 13 and a nylon bandage 14 with a belt edge protection 12 of a known type positioned between them extend over the circumference of the tire lying outside the carcass plies. Additionally, shoulder strips 10 are laid in the shoulder region. In a known manner, a tread rubber 1 completes the tire structure.

In FIG. 3 the overlapping area 18 is shown in sectional view perpendicular to the carcass yarns. The inner carcass layer 8 is thereby formed in a known manner with carcass yarns 15. The carcass yarns 15 lie in the central plane of the carcass ply 8. In the outer carcass ply 9, carcass yarns 16 are embedded in the central plane of the carcass layer 9.

During shaping and vulcanization, the carcass yarns 16 of polyester are strongly stretched and subsequently shrunk again. The polyester yarns of the overlapping ends 9″ and 9′ contract tightly thereby in the overlapping region of carcass 9. During the expansion of the tire and, therefore, of the carcass ply 9, into the operating state with excess pressure in the tire, the carcass yarns 16 stretch less in this overlapping region thus solidified than the carcass yarns outside the overlapping region of the carcass ends 9′, 9″ so that a constriction of the sidewall occurs in the overlapping region.

As shown in FIG. 4, the tire sidewall is embodied with a sidewall decoration 30 on the outside of the sidewall strip 7. The sidewall decoration 30 thereby extends in the radial direction R of the vehicle pneumatic tire between an internal radius Rᵢ and an external radius Rₐ and in the circumferential direction U of the vehicle pneumatic tire over the entire vehicle pneumatic tire. In the exemplary embodiment shown the sidewall decoration 30 is formed from three first circumferential sections I that extend over the circumferential angular sections β, δ and ζ, and from three second circumferential sections II that extend over the circumferential angular sections α, γ and ε. In the surfaces of the first circumferential sections I of the tire decoration, symbols are respectively embodied in a known manner (not shown in further detail) to provide information on the vehicle pneumatic tire, e.g., difference from other vehicle pneumatic tires or on technical details of the vehicle pneumatic tire, e.g., by giving the tire dimension. In the surfaces of the second circumferential sections II of the tire decoration, no symbols of this type are embodied in a known manner (not shown in further detail) to provide information on the vehicle pneumatic tire, e.g., difference from other vehicle pneumatic tires or on technical details of the vehicle pneumatic tire, e.g., by giving the tire dimension. The circumferential sections I and II are respectively embodied directly one behind the other in the circumferential direction in alternating sequence. On both ends of a circumferential section I embodied in the circumferential direction U, a circumferential section II begins respectively in a circumferential position represented respectively by reference number 31. On both ends of a circumferential section II embodied in the circumferential direction U, a circumferential section I begins respectively in a circumferential position represented respectively by reference number 31. The sum of the angles α, β, γ, δ, ε and ζ forms 360° in the exemplary embodiment shown. In the exemplary embodiment shown the angles α, γ and ε are chosen to be the same size: α=γ=ε. Likewise, in the exemplary embodiment shown, the angles β, δ and ζ are chosen to be the same size: β=δ=ζ. For example, as in the exemplary embodiment shown, the angles α, β, γ, δ, ε and ζ are chosen to be the same size: α=β=γ=δ=ε=ζ=60°.

The sidewall decoration 30 is a moiré pattern respectively formed by two superimposed linear patterns in the radial extension region between the internal radius Rᵢ and the external radius Rₐ in the second circumferential regions II—as shown in FIG. 6c. A moiré pattern is an interference figure of at least two superimposed linear patterns in which a brightness distribution arises from interference in the form of a standing wave.

The moiré pattern in FIG. 6c is produced by superimposing the two families of curves shown in FIG. 6a and FIG. 6b. The family of curves shown in FIG. 6a is formed by a plurality of undulatory curves with regular wave form spaced apart from one another in the radial direction of the vehicle pneumatic tire, which curves extend in the circumferential direction of the vehicle pneumatic tire.

In the embodiment shown in FIG. 6a, the family of curves is produced as follows: On an inner circular path K1 embodied concentrically to the vehicle pneumatic tire, inner centers M₁ are arranged respectively at the same angle μ to one another and on an outer circular path K2 embodied concentrically to the vehicle pneumatic tire inner are arranged respectively at the same angle ν to one another. The centers M₂ are thereby arranged respectively on the midperpendicular to two adjacent centers M₁. An identical number of circle segments with the same radial distance from the associated center M₁ or M₂ is respectively formed around the centers M₁ and the centers M₂ towards the other circular path K2 or K1 so that respectively one circle segment formed around a center M₁ merges aligned into respectively one corresponding circle segment of the adjacent center M₂. The transition occurs on a path connecting the centers M₁ and M₂.

The other family of curves, shown in FIG. 6b, is embodied from a plurality of undulatory curves with irregular wave form spaced apart from one another in each circumferential position of the vehicle pneumatic tire respectively in this circumferential position at the same radial distance r₁, which curves extend in the circumferential direction of the vehicle pneumatic tire. The zero passages of the curves occur in the same circumferential position. Circumference-related phases of the family of curves and the amplitudes change along their extension in irregular sequence. This is clearly shown in FIGS. 5c and 5d.

FIG. 6c shows the two families of curves of FIG. 6a and FIG. 6b superimposed. An interference figure of the two families of curves is formed, whereby particularly bright regions form in the region of line intersections. The entire interference figure thereby shows a brightness distribution as with an undulatory spread with a standing wave.

In sidewall decoration, the dark lines of the two families of curves are thereby fine impressed or raised grooves in the surface of the rubber. The grooves have a round or angular cross-sectional contour.

The irregular brightness distribution that is produced on the sidewall by the moiré effect is superimposed on the variation in the brightness distribution produced by the constriction of the tire sidewall. The variation in the brightness distribution produced by the constriction of the tire sidewall is no longer clearly identifiable as such. Only a non-uniform brightness distribution apparently produced by the tire decoration is recognizable.

In another embodiment, alternatively to the family of curves shown and described in FIG. 6a, a family of curves is embodied that is embodied, e.g., from a plurality of undulatory curves with regular wave form spaced apart from one another in the radial direction of the vehicle pneumatic tire at respectively the same distance, which curves extend in the circumferential direction of the vehicle pneumatic tire. The lines of the zero passages of the undulatory curves are respectively concentric circular paths, e.g., concentric to the vehicle pneumatic tire. The zero passages of the curves occur in the same circumferential position. Circumference-related phases and the amplitudes of the curves are respectively constant along the entire extension. This is clearly shown in FIGS. 5a and 5b in which for the purpose of simplification only one curve of the curve family with its zero line is drawn over the whole extension.

The sidewall decoration 30 is a moiré-free pattern formed by two overlapping linear patterns in the radial extension region between the internal radius Rᵢ and the external radius Rₐ in the first circumferential region I—as shown in FIG. 7c.

The moiré-free pattern in FIG. 7c is produced by superimposing the two families of curves shown in FIG. 7a and FIG. 7b. The family of curves shown in FIG. 7a is formed by a plurality of tangents abutting against a circle with a radius R_{T}, whereby the spacing of adjacent tangent points on the circle is respectively the same. The other family of curves, shown in FIG. 7b, is likewise formed by a plurality of tangents abutting against a circle with a radius R_{T}, whereby the spacing of adjacent tangent points on the circle is respectively the same. The pitch direction of the tangents of the first family of curves is opposite to the pitch direction of the tangents of the second family of curves. These two circles for forming the families of curves shown diagrammatically in FIGS. 7a and 7b for forming the tangents are equal in size and concentric. In one exemplary embodiment these two circles are concentric to the vehicle tire. As shown in FIG. 7c, in one exemplary embodiment the pattern is interrupted by the markings for providing information formed in the circumferential region I in the surface of the tire sidewall.

In sidewall decoration, the dark lines of the two families of curves are thereby fine embossed or raised grooves in the surface of the rubber. The grooves have a round or angular cross-sectional contour.

FIG. 8 shows in more detail the transition 31 of the families of curves of the circumferential regions I to the families of curves of the circumferential regions II at the segment border between these regions. For the sake of clarity, only every sixth curve of a family of curves is thereby shown. As can be clearly seen, respectively one curve of a first family of curves of the circumferential region II merges smoothly into a curve of a first family of curves of the circumferential region I, which curve is embodied with the same pitch in the transition 31 and corresponding thereto. As can be clearly seen, respectively one curve of a second family of curves of the circumferential region II merges smoothly into a curve of a second family of curves of the circumferential region I, which curve is embodied with the same pitch in the transition 31 and corresponding thereto. Thus, for example, the curve of the first family of curves in the circumferential region II, which curve lies innermost in the transition 31 in the radial direction of the vehicle pneumatic tire and has the angle of pitch ηᵢ embodied in the transition 31, smoothly merges into a curve of the first family of curves of the circumferential region I, which curve lies innermost in the radial direction of the vehicle pneumatic tire and is embodied with the same angle of pitch ηᵢ in the transition 31 and assigned thereto in a corresponding manner in the transition 31. Likewise the curve of the second family of curves of the circumferential region II, which curve lies innermost in the transition 31 in the radial direction of the vehicle pneumatic tire and has the angle of pitch θᵢ embodied in the transition 31, merges smoothly into a curve of the second family of curves of the circumferential region I, which curve lies innermost in the transition 31 in the radial direction of the vehicle pneumatic tire and is embodied with the same angle of pitch θᵢ in the transition 31 and assigned thereto in a corresponding manner. Likewise, for example, the curve of the first family of curves of the circumferential region II, which curve lies outermost in the transition 31 in the radial direction of the vehicle pneumatic tire and has the angle of pitch ηₐ embodied in the transition 31, merges smoothly into a curve of the first family of curves of the circumferential region I, which curve lies outermost in the transition 31 in the radial direction of the vehicle pneumatic tire and is embodied with the same angle of pitch ηₐ in the transition 31 and assigned thereto in a corresponding manner. Likewise, the curve of the second family of curves of the circumferential region II, which curve lies outermost in the transition 31 in the radial direction of the vehicle pneumatic tire and has the angle of pitch θₐ embodied in the transition 31, merges smoothly into a curve of the second family of curves of the circumferential region I, which curve lies outermost in the transition 31 in the radial direction of the vehicle pneumatic tire and has the same angle of pitch θₐ embodied in the transition 31, assigned thereto in a corresponding manner.

FIGS. 5a, 5b, 5c, 5d show an example of circumferential regions of equal size where α=β=γ=δ=ε=ζ=60°, in which the first and second families of curves shown in FIGS. 6a and 6b, designed continuously over the entire circumference of the vehicle pneumatic tire, whereby they are realized only in the circumferential regions II in the vehicle pneumatic tire to produce the moiré pattern. The imaginary continuation in the circumferential regions I shown by a broken line are not realized in the vehicle pneumatic tire, but are replaced by the families of curves shown in FIGS. 7a and 7b. As can be seen in FIGS. 5a, 5b, 5c, 5d, all the transitions 31 between the circumferential regions I and II are embodied identically.

To this end the undulatory curves of the first family of curves of the second circumferential region II shown in FIG. 6a are embodied with their frequency such that they extend between the two transitions 31 of a circumferential region II with an integer multiple of the respective wavelength. The undulatory curves of the first family of curves of the second circumferential area II shown in FIG. 6b embodied such that they both strike transition 31 at the same radial position on the vehicle pneumatic tire and with the same pitch.

It is also conceivable to embody carcass yarns of a material other than polyester yarns. It is particularly expedient to embody a tire sidewall decoration with moiré pattern in the circumferential regions II for tires in which a particularly great danger of discernible constrictions occurs.

### LIST OF REFERENCE NUMBERS

(Part of the Specification)

1 Tread rubber
2 Core
3 Bead reinforcement
4 Core profile
5 Flange profile
6 Inner layer
7 Side strips
8 Carcass ply
9 Carcass ply
10 Shoulder strips
11 Belt ply
12 Belt edge protection
13 Belt ply
14 Belt ply
15 Carcass yarn
16 Carcass yarn
17 Overlap points
18 Overlap points
19 Rubber layer
23 Bead strip
24 Family of curves
25 Family of curves
26 Moiré pattern
27 Family of curves
28 Family of curves
29 Moiré-free pattern
30 Sidewall decoration
31 Transition

1. Vehicle pneumatic tire with a carcass, in particular of radial construction, with sidewalls and with a tread rubber (1), whereby the carcass in the sidewall area is covered on the outside by a sidewall rubber strip (7), whereby in at least one first surface area of the sidewall rubber strip (7) markings for providing information are embodied, whereby at least in a second surface area of the sidewall rubber strip (7) joining the first surface area in the circumferential direction of the vehicle pneumatic tire is embodied free from markings for providing information, whereby a moiré pattern is arranged on the surface of the sidewall rubber strip (7), which pattern results formed by the superimposition of at least two linear non-identical families of curves, characterized in that in the second surface area on the sidewall rubber strip (7) a moiré pattern is arranged, which pattern results formed by the superimposition of at least two linear non-identical families of curves, and that a moiré-free pattern is arranged in the first surface area on the sidewall rubber strip (7), which pattern is embodied of one or more linear families of curves.

2. Vehicle pneumatic tire according to the features of claim 1, that in the transition of the two surface areas adjacent in the circumferential direction of the vehicle pneumatic tire curves of a first family of curves of the first circumferential section merge smoothly into respectively one curve of a first family of curves of the second circumferential section.

3. Vehicle pneumatic tire according to the features of claim 2, that in the transition of the two surface areas adjacent in the circumferential direction of the vehicle pneumatic tire curves of a second family of curves of the first circumferential section merge smoothly into respectively one curve of a second family of curves of the second circumferential section.

4. Vehicle pneumatic tire according to the features of claim 1, that in the transition of the two surface areas adjacent in the circumferential direction of the vehicle pneumatic tire respectively one curve of a first family of curves of the first circumferential section merges smoothly into respectively one curve of a first family of curves of the second circumferential section.

5. Vehicle pneumatic tire according to the features of claim 1 that in the transition of the two surface areas adjacent in the circumferential direction of the vehicle pneumatic tire respectively one curve of a second family of curves of the first circumferential section merges smoothly into the curves of a second family of curves of the second circumferential section.

6. Vehicle pneumatic tire according to the features of claim 1, that in the transition of the surface areas adjacent in the circumferential direction the curves of the family of curves of the first surface area have an identical pitch to the circumferential direction as the adjacent curve in the circumferential direction of the the family of curves of the second surface area.

7. Vehicle pneumatic tire according to the features of claim 1, that the first family of curves of the second surface area is formed by undulatory curves with regular wave form and the second family of curves of the second surface area is formed by undulatory curves with irregular wave form.

8. Vehicle pneumatic tire according to the features of claim 1, whereby the first family of curves of the second surface area is formed by undulatory curves that extend in the circumferential direction of the vehicle pneumatic tire.

9. Vehicle pneumatic tire according to the features of claim 1, whereby the second family of curves of the second surface area is formed by undulatory curves with irregular wave form, which curves extend in the circumferential direction of the vehicle pneumatic tire.

10. Vehicle pneumatic tire according to the features of claim 1, whereby the second family of curves of the second surface area is formed by undulatory curves with irregular frequency of their wave form.

11. Vehicle pneumatic tire according to the features of claim 1, whereby the second family of curves of the second surface area is formed by undulatory curves with amplitude changing along their wave extension.

12. Vehicle pneumatic tire according to the features of claim 1, whereby the moiré-free pattern of the first surface area has at least one family of curves of rectilinear curves.

13. Vehicle pneumatic tire according to the features of claim 1, whereby the moiré-free pattern of the first surface area at least one family of curves is formed by tangents abutting against a circular cylindrical circumferential surface of a cylinder concentric in particular to the vehicle pneumatic tire.

14. Vehicle pneumatic tire according to the features of claim 13, whereby the radius of the circular cylindrical circumferential surface is smaller than the radius of a cylinder embodied concentrically to the vehicle pneumatic tire, which cylinder tangentially delimits the the first surface to the radial inside on the vehicle pneumatic tire.

15. Vehicle pneumatic tire according to the features of claim 1, whereby markings to provide information are embodied in at least two first surface areas of the sidewall rubber strip (7) respectively spaced apart from one another in the circumferential direction of the vehicle pneumatic tire, whereby in a second surface area of the sidewall rubber strip (7) connecting to the first surface areas respectively between the two first surface areas in the circumferential direction of the vehicle pneumatic tire is embodied free from markings to provide information, whereby a moiré pattern is arranged in the second surface area on the sidewall rubber strip (7), which pattern is formed embodied from the superimposition of at least two linear non-identical families of curves, and whereby a moiré-free pattern is arranged in the first surface area on the sidewall rubber strip (7), which pattern is formed by one or more linear families of curves.
